(19) United States
(12) Patent Application Publication
(10) Pub. No.: US 2026/0128896 A1
(43) Pub. Date: May 7, 2026

(54) ENHANCED ZERO-KNOWLEDGE ANALYSIS

(71) Applicant: The Hong Kong University of Science and Technology, Kowloon (HK)

(72) Inventors: Pingchuan MA, Kowloon (HK); Shuai WANG, Kowloon (HK); Zhaoyu WANG, Kowloon (HK)

(21) Appl. No.: 19/257,400

(22) Filed: Jul. 1, 2025

Related U.S. Application Data
(60) Provisional application No. 63/714,883, filed on Nov. 1, 2024.

(51) Int. Cl. H04L 9/32

(52) U.S. Cl. CPC H04L 9/3221

(57) ABSTRACT

Zero-knowledge (ZK) analysis, including causal analysis, and ZK proof (ZKP) generation can be enhancedly managed and performed. A graph processor can perform first analysis of graph data of a graph relating to a cause, effect, or event based on one or more ZK graph primitives. The one or more ZK graph primitives can be tailored for causal analysis in ZK applications. A proof manager can determine and generate a ZKP, comprising computation results, relating to the cause, effect, or event, based on a second result of second analysis of result data of a first result of the first analysis, wherein the result data can comprise graph primitive data representative of or relating to the at least one ZK graph primitive. The proof manager can communicate the ZKP to a verifier to facilitate verification of correctness of the ZKP, including the computation results.

### CROSS-REFERENCE TO RELATED APPLICATION

This patent application claims priority to U.S. Provisional Patent Application No. 63/714,883, filed Nov. 1, 2024, and entitled, “A New Approach for Efficient Zero-Knowledge Causal Analysis,” the entirety of which application is hereby incorporated by reference herein.

### BACKGROUND

For a variety of applications and services, and in a variety of situations, it can be desirable to protect personal and/or sensitive data. Various cryptographic tools can be utilized to protect data. For instance, zero-knowledge proofs can be a cryptographic tool that can enable a prover to convince a verifier of the correctness of computations without revealing the underlying data utilized in performing the computations and generating the zero-knowledge proof.

The above-described description is merely intended to provide a contextual overview regarding cryptographic tools and proofs, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise performing, by a system comprising at least one processor, a first analysis of graph data that can be representative of a graph relating to a cause, an effect, or an event based on at least one zero-knowledge (ZK) graph primitive. The method also can comprise determining, by the system, a ZK proof (ZKP) relating to the cause, the effect, or the event based on a second result of a second analysis of result data of a first result of the first analysis, wherein the result data can comprise graph primitive data that can be representative of the at least one ZK graph primitive.

In certain embodiments, the disclosed subject matter can comprise a system that can comprise at least one memory that can store computer executable components, and at least one processor that can execute computer executable components stored in the at least one memory. The computer executable components can comprise a graph processor that can perform a first analysis of graph information that can be representative of a graph relating to a cause, an effect, or an event based on at least one ZK graph primitive. The computer executable components also can comprise a proof generator that can determine a ZKP relating to the cause, the effect, or the event based on a second result of a second analysis of result information of a first result of the first analysis, wherein the result information can comprise graph primitive information that can be representative of the at least one ZK graph primitive.

In still other embodiments, the disclosed subject matter can comprise a non-transitory machine-readable medium, comprising executable instructions that, when executed by at least one processor, can facilitate performance of operations. The operations can comprise performing a first analysis of graph data of a graph relating to a cause, an effect, or an event based on at least one ZK graph primitive. The operations also can comprise generating a ZKP relating to the cause, the effect, or the event based on a second result of a second analysis of result data of a first result of the first analysis, wherein the result data can comprise graph primitive data of the at least one ZK graph primitive.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably perform and manage data analysis and proof generation relating to such data analysis utilizing graph primitives, in accordance with various aspects and embodiments of the disclosed subject matter.

FIG. 2 depicts a block diagram of a non-limiting example proof manager component that can desirably perform and manage data analysis and proof generation relating to such data analysis utilizing graph primitives, in accordance with various aspects and embodiments of the disclosed subject matter.

FIG. 3 depicts a diagram of a non-limiting example directed acyclic graph (DAG) that can be representative of a non-limiting example dataset, in accordance with various aspects and embodiments of the disclosed subject matter.

FIG. 4 illustrates a block diagram of a non-limiting example verifier manager component that can desirably verify proofs, which can relate to analysis performed on datasets or information relating thereto, received from proof manager components, such as the proof manager component, in accordance with various aspects and embodiments of the disclosed subject matter.

FIG. 5 illustrates a flow chart of an example method that can desirably perform and manage data analysis and proof generation relating to such data analysis utilizing one or more graph primitives, in accordance with various aspects and embodiments of the disclosed subject matter.

FIG. 6 depicts a flow chart of an example method that can desirably perform and manage data analysis and proof generation relating to such data analysis utilizing a graph primitive that can facilitate identification of descendant nodes and ancestor nodes of a node in a graph, in accordance with various aspects and embodiments of the disclosed subject matter.

FIG. 7 illustrates a flow chart of an example method that can desirably perform and manage data analysis and proof generation relating to such data analysis utilizing a graph primitive that can facilitate determining whether a graph is acyclic and performing acyclic or cyclic graph processing, in accordance with various aspects and embodiments of the disclosed subject matter.

FIG. 8 depicts a flow chart of an example method that can desirably perform and manage data analysis and proof generation relating to such data analysis utilizing a graph primitive that can facilitate assessing whether a first subgroup of nodes and a second subgroup of nodes of a group of nodes of the graph are d-separated, in accordance with various aspects and embodiments of the disclosed subject matter.

FIG. 9 illustrates a flow chart of an example method that can desirably perform and manage data analysis and proof generation relating to such data analysis utilizing a graph primitive that can facilitate generating an interventional graph for a target node of a graph to facilitate eliminating or mitigating influences of other nodes of the graph on the target node, in accordance with various aspects and embodiments of the disclosed subject matter.

FIG. 10 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that desirably (e.g., suitably, accurately, quickly, efficiently, reliably, enhancedly, or optimally) can manage and perform zero-knowledge (ZK) analysis, including causal analysis, and generate zero-knowledge proofs (ZKPs). Various cryptographic tools can be utilized to protect data. For example, ZKPs can be a cryptographic tool that can enable a prover to convince a verifier of the correctness of computations without revealing the underlying data utilized in performing the computations and generating the ZKP.

Causal analysis can play a significant and useful role in understanding the relationships and dependencies among variables in various fields, including, for example, epidemiology, economics, and machine learning. For instance, causal analysis can be a systematic approach aimed at unraveling the causal relationships between random variables. Central to this analysis can be causal primitives, which include both graph operators and numerical operators. These primitives can facilitate desired (e.g., significant, fundamental, or essential) operations such as, for example, conditioning, intervention, and counterfactual reasoning, which can form the foundation for advanced causal analysis algorithms. By leveraging causal analysis, researchers and practitioners can gain a comprehensive understanding of complex relationships, which can lead to more informed decision-making across various domains, including healthcare, economics, and social sciences.

However, the desire (e.g., want or need) for privacy protection in these analyses can be paramount, especially when sensitive or personal data is involved, and the growing emphasis on data privacy can presents significant challenge for causal analysis. In many real-world scenarios, the data involved, such as, for example, patient records or financial information, can be sensitive and subject to stringent privacy regulations. Some existing methods of causal analysis may inadvertently and undesirably expose this sensitive or personal data to unauthorized access or breaches, which can heighten privacy concerns. Even in cases where raw data is not directly disclosed, intermediate results can still potentially reveal sensitive information about the underlying data, which can pose substantial risks.

In cloud-based environments, users often can request service providers to perform causal analyses on private data or causal graphs with increasing demands for transparency. As this information can be stored in the cloud, users frequently can demand transparency, insisting that service providers disclose data or causal graphs. Meanwhile, service providers can be reluctant to release this information due to concerns over data privacy and commercial secrets. For service providers, since such data and causal graphs can represent commercial secrets and sensitive information, this can create a desire for solutions that can ensure privacy while convincingly demonstrating that the correct data or causal graphs are being used for causal analysis.

In response to these challenges, ZKPs can offer a promising and robust solution, as ZKPs can enable parties to verify the correctness of computations without revealing the actual underlying data involved. This can be achieved through the use of ZK circuits, which can enable one to prove knowledge of certain information without disclosing the information itself. By integrating ZKPs into the causal analysis framework, valuable insights can be extracted from data and causal graphs without compromising sensitive information or trade secrets, which can thereby foster trust and compliance in data-driven decision-making processes. However, existing ZK tools can be deficient and inefficient if used for causal analysis and certain other types of analysis and when applying existing general-purpose ZK frameworks to these tasks.

It can be desirable (e.g., suitable, beneficial, advantageous, wanted, useful, improved, or optimal) to have a ZKP generation system, method, and technique that can address the challenges of desirably performing causal analysis and other types of analysis under ZK conditions, and determining and generating ZKPs relating to causal analysis and other types of analysis. To that end, systems, methods, and techniques that can desirably address the challenges of performing causal analysis and other types of analysis under ZK conditions, and determining and generating ZKPs relating to causal analysis and other types of analysis, are presented. In accordance with various embodiments, a system can comprise a proof manager component that can desirably (e.g., automatically, dynamically, suitably, reliably, efficiently, enhancedly, and/or optimally) manage and perform causal analysis and other types of analysis under ZK conditions and generation of proofs (e.g., ZKPs) relating to causal analysis and other types of analysis. In some embodiments, the proof manager component can comprise a graph processor component that can perform a first analysis (e.g., causal analysis or other type of analysis) of graph data that can be representative of a graph relating to a cause(s), effect(s), and/or event(s) based at least in part on one or more graph primitives (e.g., one or more ZK graph primitives), wherein the graph can be representative of a dataset relating to a desired topic(s) or subject(s).

In certain embodiments, the one or more graph primitives can be tailored (e.g., customized or adapted) for causal analysis and/or other desired type of analysis under ZK conditions and in ZK applications. The one or more graph primitives can comprise, for example, a first graph primitive that can be utilized to identify descendant nodes and ancestor nodes of a node (e.g., for each node) in a graph (e.g., a causal directed acyclic graph (DAG), causal graph, or other graph), a second graph primitive that can determine whether a graph is acyclic and can perform acyclic or cyclic graph processing (e.g., depending in part on whether the graph is acyclic or not), a third graph primitive that can assess whether two subgroups of a group of nodes of a graph (e.g., DAG) are d-separated, a fourth graph primitive that can generate an interventional graph for a target node of a graph to facilitate eliminating or mitigating (e.g., reducing or minimizing) influences of other nodes of the graph on the target node, and/or another desired graph primitive, such as described herein.

In some embodiments, the proof manager component also can comprise a proof generator component that can determine and generate a proof (e.g., a ZKP), which can comprise analysis and/or computational results, relating to the cause(s), effect(s), and/or event(s), based at least in part on a second result of a second analysis of result data of a first result of the first analysis (e.g., the causal analysis or other type of analysis) and a cryptographic key (e.g., a private encryption key), wherein the result data can comprise graph primitive data that can be representative of or can relate to the one or more graph primitives employed during the analysis and proof generation.

In certain embodiments, the proof manager component can communicate the proof (e.g., ZKP) to a verifier (e.g., a verifier component or device) to facilitate verification of correctness of the proof by the verifier, including verification of the analysis and/or computational results of the proof. For instance, the proof can enable the proof manager component to convince the verifier of the correctness (e.g., accuracy) of computations of the proof (and the graph) without revealing the underlying data that was utilized to perform the computations, and determine and generate the proof.

The disclosed subject matter, by employing the proof manager component and the enhanced techniques (e.g., enhanced analysis (e.g., causal analysis) techniques, enhanced proof generation techniques) described herein, desirably (e.g., automatically, dynamically, suitably, reliably, efficiently, enhancedly, and/or optimally) can perform analysis (e.g., causal analysis and/or other analysis under ZK conditions) on data (e.g., graphs and/or datasets (e.g., datasets utilized to generate graphs)), and determine and generate proofs relating to the data analysis. The disclosed subject matter, by employing the proof manager component and the enhanced techniques (e.g., enhanced analysis (e.g., causal analysis) techniques, enhanced proof generation techniques) described herein, also desirably (e.g., automatically, dynamically, suitably, reliably, efficiently, enhancedly, and/or optimally) can protect personal, sensitive, proprietary (e.g., trade secrets), and/or confidential information from undesired disclosure to other entities, while generating proofs, comprising analysis and computational results relating to such personal, sensitive, proprietary, and/or confidential information, that can be utilized by another entity or device to verify and trust in the correctness of the analysis and computational results. This can enable and contribute to more informed decision-making that can be based on robust, privacy conscious insights. The disclosed subject matter, by employing the proof manager component and the enhanced techniques (e.g., enhanced analysis (e.g., causal analysis) techniques, enhanced proof generation techniques) described herein, also desirably (e.g., automatically, dynamically, suitably, reliably, efficiently, enhancedly, and/or optimally) can result in more efficient implementation in graph primitives in ZK circuits, which can enhance both performance and scalability of systems and processes for analysis (e.g., causal analysis and/or other analysis) and proof generation.

These and other aspects and embodiments of the disclosed subject matter will now be described with respect to the drawings.

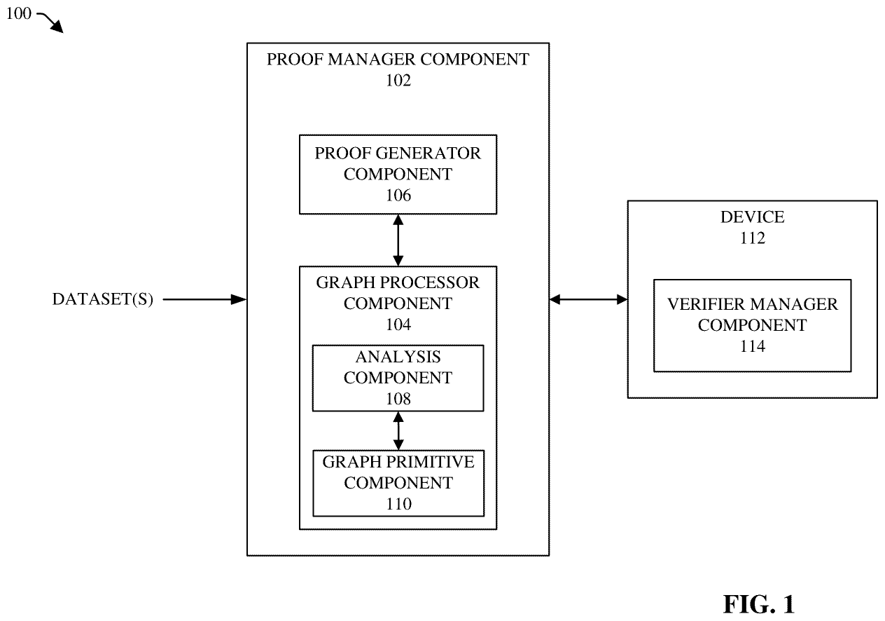

Referring now to the drawings, FIG. 1 illustrates a block diagram of a non-limiting example system 100 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing graph primitives (e.g., tailored or customized graph primitives), in accordance with various aspects and embodiments of the disclosed subject matter. In some embodiments, the system 100 can comprise a proof manager component 102 that can desirably perform and manage the data analysis and proof (e.g., ZKP) generation relating thereto. In accordance with various embodiments, the proof manager component 102 can be part of or associated with (e.g., communicatively connected to) one or more devices (e.g., one or more servers), such as described herein. In certain embodiments, the proof manager component 102 can receive data for processing and analysis from one or more devices (not shown in FIG. 1).

In accordance with various embodiments, the proof manager component 102 can comprise a graph processor component 104 and a proof generator component 106, wherein the graph processor component 104 can comprise an analysis component 108 and a graph primitive component 110. In some embodiments, the graph processor component 104, employing the analysis component 108 and the graph primitive component 110 (e.g., one or more graph primitives of the graph primitive component 110), can perform an analysis (e.g., causal analysis or other analysis) on graph data of a graph(s) that can be representative of a dataset(s) (e.g., a group(s) of data), utilizing one or more desired graph primitives (e.g., one or more tailored or customized graph primitives), to generate analysis results (e.g., causal analysis results or other results) relating to the dataset(s) in connection with generation of a proof (e.g., ZKP) relating to such analysis and dataset(s), in accordance with defined proof management criteria, such as described herein. In certain embodiments, the proof generator component 106 can generate the proof (e.g., ZKP) relating to such analysis and dataset(s), wherein the proof can enable the prover (e.g., the proof manager component 102 or entity associated therewith) to convince a verifier (e.g., a verifier device or entity associated therewith) of the correctness of the analysis and computations performed in generating the proof without revealing the underlying data utilized in performing the analysis and computations, and generating the proof, in accordance with the defined proof management criteria, such as described herein.

In accordance with various embodiments, the one or more graph primitives (e.g., causal primitives), which can be utilized in connection with such analysis (e.g., causal analysis) of data and generation of the proof relating thereto, can be tailored and/or designed for causal analysis in applications, such as ZK applications, in accordance with the defined proof management criteria. The graph primitives can include graph operators and numerical operators. The graph primitives can facilitate desired (e.g., wanted, useful, or significant) operations, such as, for example, conditioning, intervention, and counterfactual reasoning, which can form the foundation for advanced causal analysis algorithms. By leveraging causal analysis, users (e.g., researchers, practitioners, and/or other users) can gain a comprehensive understanding of complex relationships, which can lead to more informed decision-making across various domains, including healthcare, medicine, science, economics, social sciences, climate, marketing, engineering, manufacturing, and/or another desired domain.

The one or more graph primitives can comprise, for example, a first graph primitive (e.g., first ZK graph primitive and/or an ancestor/descendant identifier graph primitive) that can be utilized to identify descendant nodes and ancestor nodes of a node (e.g., for each node) in a graph (e.g., causal DAG, causal graph, or other graph), a second graph primitive (e.g., second ZK graph primitive and/or an acyclic graph identifier graph primitive) that can determine whether a graph is acyclic and can perform acyclic or cyclic graph processing (e.g., depending on whether the graph is acyclic or not), a third graph primitive (e.g., third ZK graph primitive and/or an d-separation identifier graph primitive) that can assess whether two subgroups of a group of nodes of the graph (e.g., DAG) are d-separated, a fourth graph primitive (e.g., fourth ZK graph primitive and/or an interventional graph generating graph primitive) that can generate an interventional graph for a target node of the graph to facilitate eliminating or mitigating (e.g., reducing or minimizing) influences of other nodes of the graph on the target node, and/or another desired graph primitive, such as described herein. In some embodiments, these graph primitives can be developed by transforming graph operators into matrix algorithms, enhancing computational complexity by leveraging the unique properties of adjacency matrices relating to or otherwise associated with causal graphs, such as described herein. These graph primitives (e.g., tailored or customized graph primitives) and the disclosed techniques can result in calculations that can be desirably less complex, can reduce the verification complexity of matrix computations, can lead to or result in a more efficient implementation of graph primitives in ZK circuits, can enhance performance and scalability of systems and processes for analysis (e.g., causal analysis and/or other analysis) and proof generation, and can enhance the efficiency and applicability of proofs, such as ZKPs, in causal analysis and other analysis.

In some embodiments, the proof manager component 102 can be associated with (e.g., communicatively connected to) a device 112 (e.g., verifier device), which can receive one or more proofs generated by the proof manager component 102 for verification and to obtain computational results (e.g., causal analysis results or other analysis results), such as described herein. In certain embodiments, the device 112 can comprise a verifier manager component 114 that can verify the proofs, including the computational results (e.g., causal analysis results or other results), relating to datasets that can be received from the proof manager component 102. It is to be appreciated and understood that, for reasons of brevity and clarity, FIG. 1 depicts only one device 112 (e.g., one verifier device), however, at various times, the proof manager component 102 can be associated with virtually any desired number of verifier devices that can receive proofs from the proof manager component 102 for verification and to obtain computational results. It also is to be appreciated and understood that, while various embodiments of the disclosed subject matter described herein relate to causal analysis of data, the techniques and embodiments of the disclosed subject matter relating to proof generation can be utilized or applied to virtually any type of dataset or workflow, which can include relatively larger or relatively smaller datasets or workflows.

In accordance with various embodiments, a device (e.g., the one or more devices comprising or associated with the proof manager component 102, the device 112, or other device) can be a computer, a laptop computer, a server, a wireless, mobile, or smart phone, an electronic pad or tablet, a VA device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device.

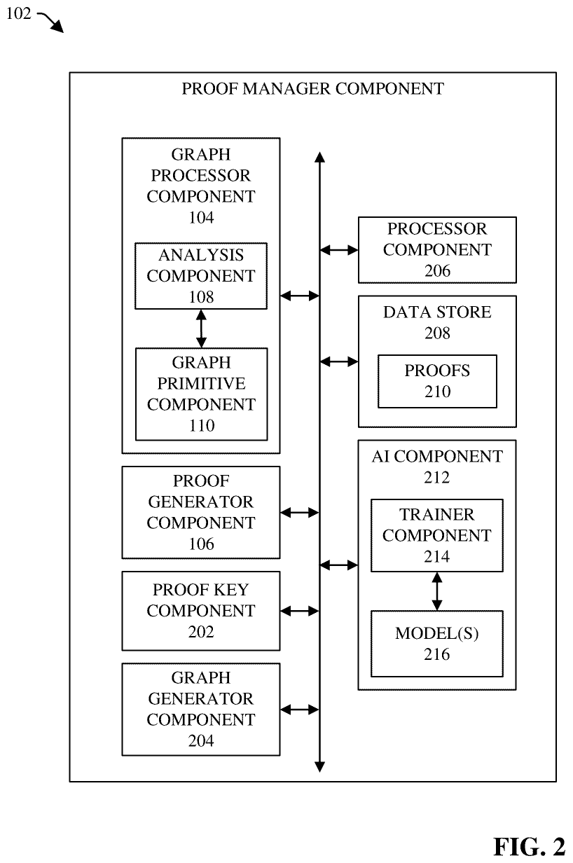

Referring to FIG. 2 (along with FIG. 1), FIG. 2 depicts a block diagram of a non-limiting example proof manager component 102 that can desirably (e.g., automatically, dynamically, suitably, reliably, efficiently, enhancedly, and/or optimally) perform and manage data analysis (e.g., causal analysis, correlation analysis, and/or other type of analysis) and proof (e.g., ZKP) generation relating to such data analysis utilizing graph primitives, in accordance with various aspects and embodiments of the disclosed subject matter. In accordance with various embodiments, the proof manager component 102 can comprise the graph processor component 104, the proof generator component 106, the analysis component 108, the graph primitive component 110, a proof key component 202, and/or a graph generator component 204. In certain embodiments, the proof manager component 102 can comprise (as depicted) or be associated with (e.g., communicatively connected to) a processor component 206 and a data store 208. In some embodiments, the proof manager component 102 can store proofs 210 relating to datasets, and other desired data, in the data store 208, such as described herein. In accordance with various embodiments, the proof manager component 102 can comprise or can be associated with an artificial intelligence (AI) component 212, which can comprise a trainer component 214 and one or more models 216 (e.g., AI-based models).

In some embodiments, the proof manager component 102 can receive a dataset(s) from another device or can retrieve the dataset(s) (e.g., a previously received and stored dataset) from the data store 208. The dataset(s) can be or can relate to healthcare and/or medicine, science, economics, social sciences, climate (e.g., climate change), marketing, engineering, manufacturing, and/or another desired topic or issue, or can be another type of dataset. In certain embodiments, the graph generator component 204 can determine and generate a graph (e.g., a DAG or other desired type of graph) that can be representative of the dataset(s), based at least in part on the results of analyzing the data of the dataset(s). In some embodiments, the graph can be a causal graph (e.g., causal DAG or other causal graph) that can be utilized in the analysis (e.g., causal analysis or other analysis). In certain embodiments, the graph can comprise a group of nodes where respective nodes can be associated with (e.g., connected to) respective other nodes of the node group via respective edges (e.g., connectors), wherein the respective edges can have respective data dependencies, depending in part on the dataset(s). For instance, a first node can have an edge associated with its output, and the other end of the edge can be associated with an input of a second node, wherein data output from the first node can be communicated, via the edge, to the input of the second node. The respective nodes of the node group can be representative of or associated with respective computational tasks or operations that can be performed within the graph (e.g., by the proof manager component 102) on respective portions of the dataset(s), and/or on data generated by other nodes of the node group, to determine and generate the proof, including computational results, based at least in part on the results of analyzing the dataset(s).

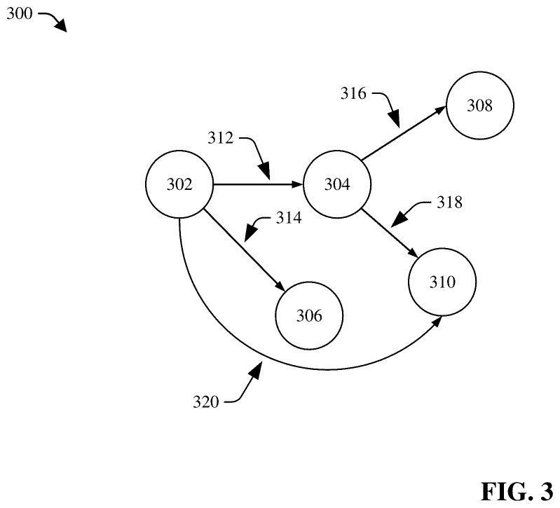

Referring briefly to FIG. 3 (along with FIGS. 1 and 2), FIG. 3 depicts a diagram of a non-limiting example DAG 300 that can be representative of a non-limiting example dataset, in accordance with various aspects and embodiments of the disclosed subject matter. In some embodiments, the example DAG 300 can comprise a group of nodes, which can include node 302, node 304, node 306, node 308, and node 310. In certain embodiments, the example DAG 300 also can comprise a group of edges, which can include edge 312, edge 314, edge 316, edge 318, and edge 320, wherein respective edges can be associated with (e.g., connected to) respective outputs of certain respective nodes and can be associated with respective inputs of certain other respective nodes, and wherein the arrangement of the nodes and the arrangement of the edges can be based at least in part on the dataset. It is to be appreciated and understood that the number of nodes, the number of edges, the arrangement of the nodes, and the arrangement of the edges in relation to the nodes in the example DAG 300 is merely one non-limiting example, and depending in part on the respective data of respective datasets, respective DAGs, which can be representative of the respective datasets, can have respective (e.g., different or unique) numbers of nodes, respective numbers of edges, respective arrangements of nodes, and respective arrangements of edges in relation to nodes.

With further regard to FIGS. 1 and 2, in certain embodiments, the graph processor component 104, employing the analysis component 108 and the graph primitive component 110, can perform an analysis (e.g., a causal analysis or other desired type of analysis) on the graph to generate analysis results (e.g., causal analysis results or other analysis results) in connection with generation of a proof (e.g., by the proof generator component 106) relating to such analysis, in accordance with the defined proof management criteria. In some embodiments, the graph primitives, associated proof-related circuits (e.g., ZK circuits), and associated operations can be tailored to facilitate desirable and efficient performance of causal analysis on data (e.g., graph data of graphs and/or other data), without incorporating or performing undesirable, extraneous, and/or inefficient operations. It is to be appreciated and understood that, in accordance with various embodiments, an analysis by the graph processor component 104 can involve one or more graphs relating to or representative of one or more datasets, and/or utilization of one or more graph primitives as part of the analysis.

In certain embodiments, the first graph primitive (e.g., first ZK and/or ancestor/descendant identifier graph primitive) can be utilized to identify descendant nodes and ancestor nodes of a node, for each node, in the graph (e.g., causal DAG or other graph). The process for this first graph primitive can comprise preprocessing of the graph, circuit (e.g., ZK circuit) constraints, matrix inversion, and descendant and ancestor identification. In some embodiments, as part of the analysis and preprocessing, with regard to a graph A (e.g., causal DAG A) representative of a dataset(s), the graph processor component 104 can determine (e.g., compute) a transformation matrix P outside the circuit such that B=P⁻¹AP can result in an upper triangular matrix B with zeros on its diagonal, where P can satisfy a condition that Σⱼpᵢⱼ=1 and Σᵢpᵢⱼ=1. In certain embodiments, within the circuit, the graph processor component 104 can enforce a group of constraints, wherein the group of constraints can comprise a constraint that matrix B be an upper triangular matrix with zero values on its diagonal, and a constraint that matrices P and P⁻¹ can satisfy the property that each row and column of the matrices can sum to a value of 1. In some embodiments, additionally, the graph processor component 104 can ensure another constraint (e.g., of the constraint group) that P·P⁻¹=I can be satisfied (e.g., using Freivalds' algorithm or other desired technique or algorithm), wherein I can be the identity matrix.

In some embodiments, as part of the analysis, the graph processor component 104 (e.g., employing the analysis component 108 and graph primitive component 110) can perform a matrix inversion wherein the graph processor component can determine (e.g., calculate) (I−B)⁻¹ outside the circuit, and can use Freivalds' algorithm to verify the constraint that (I−B)⁻¹(I−B)=I within the circuit. In certain embodiments, as part of the analysis, the graph processor component 104 can perform descendant and ancestor identification for the nodes of the graph, wherein, in the resulting matrix (I−B)⁻¹, if the graph processor component 104 determines that the entry at the i-th row and j-th column is 1, the graph processor component 104 can determine that node j can be a descendant of node i, which can make node i an ancestor node of node j.

In some embodiments, with regard to the second graph primitive (e.g., second ZK and/or acyclic graph identifier graph primitive) that can be utilized to determine whether a graph A (e.g., causal graph A) is acyclic and can perform acyclic or cyclic graph processing (e.g., depending on whether the graph is acyclic or not), the graph processor component 104 (e.g., employing the analysis component 108 and graph primitive component 110) can perform a process for this second graph primitive that can comprise cycle detection, acyclic graph processing, and/or cyclic graph processing. In some embodiments, as part of the analysis of the graph A, the graph processor component 104 can check (e.g., examine or assess) for the presence of cycles in the graph A outside the circuit.

In certain embodiments, as part of the analysis for this second graph primitive, if the graph processor component 104 determines that the graph A is acyclic, the graph processor component 104 can determine (e.g., compute) the transformation matrix P such that B=P⁻¹AP, wherein B can be an upper triangular matrix with zero values on its diagonal, and the transformation matrix P can satisfy the condition that Σⱼpᵢⱼ=1 and Σᵢpᵢⱼ=1. In some embodiments, within the circuit, the graph processor component 104 can enforce the group of constraints (e.g., the group of constraints described with regard to the first graph primitive), wherein the group of constraints can comprise the constraint that matrix B be an upper triangular matrix with zero values on its diagonal, the constraint that matrices P and P⁻¹ can satisfy the property that each row and column of the matrices can sum to a value of 1, and the constraint that P·P⁻¹=I can be satisfied (e.g., using Freivalds' algorithm or other desired technique or algorithm), wherein I can be the identity matrix.

In certain embodiments, as part of the analysis for this second graph primitive, if, instead, the graph processor component 104 determines that the graph A is cyclic (e.g., if cycles are detected by the graph processor component 104), the graph processor component 104 can determine (e.g., compute) a path that can correspond to one of the cycles outside the circuit and can enforce the constraint that the path starts and ends at the same node within the circuit.

In some embodiments, with regard to the third graph primitive (e.g., third ZK and/or d-separation identifier graph primitive) that can assess whether respective subgroups (e.g., subgroup of nodes A and subgroup of nodes B) of a group of nodes S of the graph (e.g., causal DAG) G are d-separated, the graph processor component 104 (e.g., employing the analysis component 108 and graph primitive component 110) can perform a process for this third graph primitive that can comprise graph pruning, moralization, node removal, and/or path testing. In certain embodiments, as part of the analysis, with regard to a graph G (e.g., causal DAG G) representative of a dataset(s), and the subgroup of nodes A, subgroup of nodes B, and group of nodes S of the graph, the graph processor component 104 can perform graph pruning to remove all nodes that can be determined to not be in the ancestor group (e.g., ancestor set) A∪B∪S to obtain (e.g., generate or realize) the subgraph G_{ancestor}(A∪B∪S) (e.g., ancestor subgraph G_{ancestor}).

In some embodiments, as part of the analysis, the graph processor component 104 can perform moralization on the remaining graph (e.g., ancestor subgraph G_{ancestor}) generate (e.g., produce) a moral subgraph (G_{ancestor}(A∪B∪S))ₘ. In certain embodiments, the graph processor component 104 and the third graph primitive can achieve or perform the generation of the moral subgraph by determining (e.g., computing) GG^{T} to obtain (e.g., generate) G′, and can verify the condition G′=GG^{T} using, for example, Freivalds' algorithm, wherein G^{T} can be a transpose of the matrix G (e.g., a transpose of the matrix (e.g., adjacency matrix) that can be representative of the graph G). In some embodiments, the graph processor component 104 and the third graph primitive can set edges in the graph G that can correspond to non-zero positions in G′ to a 1 value to form the moral graph while adding corresponding constraints. In certain embodiments, with regard to the constraints, letting [symbol] (x) be an indicator function that can equal 1 when x=0 and 0 otherwise, the constraints can be expressed as:

$$( 1 - ( {G}_{ij}^{′} ) ) * {G}_{ij} + ( {G}_{ij}^{′} ) * ( 1 - {G}_{ij} ) = 1.$$

In certain embodiments, as part of the analysis, the graph processor component 104 can remove all of the nodes that are in the group S from the moral subgraph (G_{ancestor} (A∪B∪S))ₘ to generate subgraph G″ by setting the corresponding rows and columns to zero values, along with a desired group of constraints. The desired group of constraints can comprise, for example,

$${( {( {G}_{ancestor} ( A ⋃ B ⋃ S ) )}_{m} )}_{i , :} = 0 , and$$

$${( {( {G}_{ancestor} ( A ⋃ B ⋃ S ) )}_{m} )}_{: , i} = 0$$

for i in group S. These constraints can ensure that the entire i-th column and i-th row can be 0 whenever i∈S. In some embodiments, as part of the analysis, the graph processor component 104 can perform path testing, wherein the graph processor component 104 can test (e.g., check, examine, or assess) for the existence of a path between the subgroup of nodes A and the subgroup of nodes B in the subgraph G″ by determining (e.g., calculating) G′″=G″+ . . . +G″ⁿ while adding and enforcing constraints for this operation using, for example, Freivalds' algorithm, wherein n can be a desired number, wherein such constraints can comprise G″⁽ⁱ⁺¹⁾=G″ⁱ·G for i in 1 to n−1, and G′″=G″+ . . . +G″ⁿ. In certain embodiments, if the graph processor component 104 determines that any entry at the i-th row and j-th column in the subgraph (or corresponding matrix) G′″ is a non-zero value, this can indicate that there is a path where node i can reach node j, (e.g., there can be a path between node i and node j), and the graph processor component 104 can determine that there is no d-separation between the subgroup of nodes A and the subgroup of nodes B. If, instead, the graph processor component 104 determines that no such path exists (e.g., there is no entry at the i-th row and j-th column in the subgraph (or corresponding matrix) G″ that is a non-zero value), this can indicate or confirm that there can be d-separation between the subgroup of nodes A and the subgroup of nodes B, and the graph processor component 104 can determine that there can be d-separation between the subgroup of nodes A and the subgroup of nodes B.

In some embodiments, the fourth graph primitive (e.g., fourth ZK and/or interventional graph generating graph primitive) can be utilized to generate an interventional graph for a target node S of the graph to facilitate eliminating or mitigating the influence of other nodes on the target node S. For instance, as part of the analysis, the graph processor component 104 (e.g., employing the analysis component 108 and graph primitive component 110) can modify an adjacency matrix associated with the graph (e.g., causal DAG) by setting entries in a column of the adjacency matrix corresponding to the target node S to zero values, wherein the modification of the adjacency matrix can facilitate eliminating or mitigating influences of other nodes of the graph on the target node S. In certain embodiments, the graph processor component 104 can add one or more constraints to ensure that the modification of the adjacency matrix can be enforced within the ZK circuit. With regard to the one or more constraints, letting the adjacency matrix associated with the graph be G, the one or more constraints can comprise, for example, G_{:,s}=0.

In some embodiments, based at least in part on the results of the analysis (e.g., causal analysis or other analysis) of the graph(s) representative of the dataset(s), utilizing the one or more graph primitives, and/or in conjunction with such analysis, the proof generator component 106 can determine and generate a proof (e.g., a ZKP), comprising results (e.g., computational results) relating to and/or representative of the results of the analysis, in accordance with the defined proof management criteria. For instance, based at least in part on the analysis results and a cryptographic key (e.g., a private encryption key), the proof generator component 106 can determine and generate the proof, comprising the results relating to and/or representative of the analysis results, wherein the proof can be utilized to convince the verifier (e.g., a verifier device (e.g., 112) or entity associated therewith) of the correctness of the analysis and computations performed in generating the proof without revealing the underlying data utilized in performing the analysis and computations.

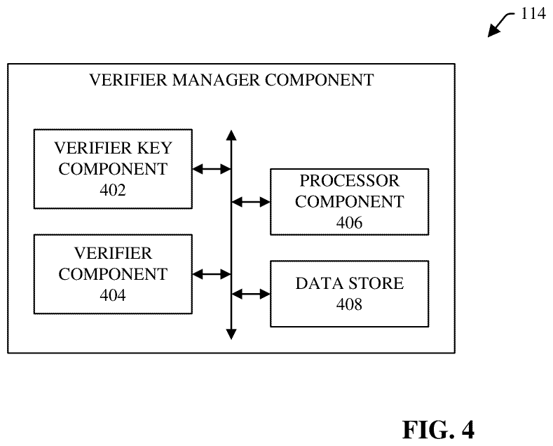

In some embodiments, the proof manager component 102 can communicate the proof (e.g., the ZKP), comprising the results, to the device 112 (e.g., the verifier device) for verification and to obtain and/or utilize (e.g., further process or otherwise utilize) the results. Turning to FIG. 4 (along with FIGS. 1-3), FIG. 4 illustrates a block diagram of a non-limiting example verifier manager component 114 that can desirably (e.g., automatically, dynamically, suitably, efficiently, reliably, enhancedly, and/or optimally) verify proofs, which can relate to analysis (e.g., causal analysis or other analysis) performed on datasets or information (e.g., graphs representative of the datasets) relating thereto, received from proof manager components, such as the proof manager component 102, in accordance with various aspects and embodiments of the disclosed subject matter. In some embodiments, the verifier manager component 114 can comprise a verifier key component 402 and a verifier component 404. In certain embodiments, the verifier manager component 114 can comprise or be associated with a processor component 406 and a data store 408.

In certain embodiments, the verifier component 404 can verify the correctness of received proofs, including verification of the results (e.g., computational results) of the proofs, based at least in part on the results of analyzing (e.g., evaluating) the proofs. In some embodiments, the proof, including the results, can be secured (e.g., encrypted using the cryptographic key of the proof key component 202 of the proof manager component 102). In accordance with such embodiments, the verifier component 404 can utilize a cryptographic key (e.g., a decryption key, which can be a public decryption key) of the verifier key component 402 that can decrypt the information (e.g., encrypted information) of the proof and facilitate verification of the proof, including the results. In certain embodiments, the decryption key can correspond to, can be consistent with, and/or can be determined and generated based at least in part on the encryption key (e.g., of the proof key component 202 of the proof manager component 102) that was used to determine and generate the proof. Based at least in part on the results of analyzing the proof and/or the decryption of the proof, the verifier component 404 can verify the correctness of the proof, including verification of the results of the proof. For instance, the proof can enable the proof manager component 102 to convince the verifier component of the correctness (e.g., accuracy) of the computations (e.g., underlying computations), and the results (e.g., results that can be accessible to the verifier component 404), of the proof relating to the analysis (e.g., causal analysis or other analysis) of the underlying data without revealing (e.g., by preventing, inhibiting, and/or not allowing the revealing of) the underlying data (e.g., private, secure, and/or proprietary data) of the dataset or intermediate analysis data that was utilized (e.g., by the proof manager component 102) to perform the computations and determine and generate the proof. That is, the verifier component 404, by successfully verifying the proof, including the results, can have confidence that the proof, including the results and the underlying computations, are correct, even though the verifier component 404 may not be able to access the underlying data to independently verify the proof, including the results and the underlying computations, utilizing the underlying data.

With further regard to the AI component 212 of FIG. 2, in accordance with various embodiments, the AI component 212 and/or the model 216 can perform an AI-based analysis on data, such as information relating to datasets (e.g., data analytics flows or other datasets), graphs, subgraphs, matrices, circuits (e.g., ZK circuits), proofs, computational tasks, computational results, hashed values, applications, services, attributes, operations, functions, parameters, events, and/or other types of data, and/or feedback information (e.g., feedback information from a user, a device, or another data source). In some embodiments, with regard to a model 216, the AI component 212 can input such information into the (trained) model 216 for analysis (e.g., AI-based analysis) by the model 216 to update the model 216 or to generate output results (e.g., AI-related data relating to graphs, subgraphs, matrices, circuits, proofs, computational tasks, computational results, and/or other output results) based at least in part on the analysis of the input information.

In connection with or as part of such an AI-based analysis, the AI component 212 can employ, build (e.g., construct or create), and/or import, AI-based techniques and algorithms, AI-based models 216 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns relating to performing analysis (e.g., causal analysis, correlation analysis, and/or other analysis) of graphs that can be representative of datasets, determining or learning about patterns relating to use of graph primitives in connection with performing analysis of graphs that can be representative of datasets, determining or learning about patterns relating to determination and generation of proofs relating to analysis of graphs that can be representative of datasets, determining or learning about patterns relating to computational tasks associated with graphs, subgraphs, and/or matrices, performing other desired functions or operations, and/or automating one or more functions or features of the disclosed subject matter, as more fully described herein.

The AI component 212 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 212 can examine the entirety or a subset of the data (e.g., the training data; operational data relating to operation of the proof manager component 102 and/or one or more servers or other devices; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 212 and/or the trained model(s) 216 can employ one or more threshold probabilities (e.g., threshold probability values) to facilitate making a determination. For instance, in making a determination (e.g., a determination relating to a causal analysis (e.g., determination of a cause(s) and an effect(s)), a determination of which graph primitive to utilize in connection with a causal analysis or other type of analysis, or other determination), as part of the AI-based analysis of information, the AI component 212 and/or the trained model(s) 216 can determine a probability (e.g., a probability that a first event, state, or variable is a cause of occurrence of a second event, state, or variable, a probability that utilization of a particular graph primitive(s) can more useful or favorable than another graph primitive(s), or other probability), and can determine whether the probability (e.g., probability value) satisfies (e.g., meets or exceeds; or is at or greater than) a defined and applicable threshold probability. The AI component 212 and/or the trained model(s) 216 can make a determination (or prediction or inference) (e.g., a determination (or prediction or inference) of whether the first event, state, or variable is the cause of the occurrence of the second event, state, or variable, a determination (or prediction or inference) of whether utilization of the particular graph primitive(s) can more useful or favorable than the other graph primitive(s), or other determination (or prediction or inference)) based at least in part on the results of analyzing (e.g., comparing) the probability to the defined and applicable threshold probability (e.g., threshold minimum probability value). As a non-limiting example, the AI component 212 and/or the trained model(s) 216 can make a determination (or prediction or inference) that the first event, state, or variable is the cause of the occurrence of the second event, state, or variable based at least in part on determining that a probability that the first event, state, or variable is the cause of the occurrence of the second event, state, or variable satisfies the defined and applicable threshold probability (e.g., the probability is the highest probability, relative to other probabilities relating to whether another event, state, or variable is the cause of the occurrence of the second event, state, or variable, and satisfies the defined and applicable threshold probability). In other embodiments, the AI component 212 and/or the trained model(s) 216 can make a determination (or prediction or inference) that the first event, state, or variable is the cause of the occurrence of the second event, state, or variable based at least in part on determining that a probability that the first event, state, or variable is the cause of the occurrence of the second event, state, or variable is a highest probability relative to the other probabilities, without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 212 can employ a classifier that can perform an AI-based analysis on data. A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 212 (e.g., employing the trainer component 214) can comprise, generate, and/or train (e.g., iteratively train) AI-based models 216 that can be trained to learn, determine, predict, or infer data patterns in data; a correlation, relationship, or causation between an item(s) of data (or an event relating thereto) and another item(s) of data (e.g., occurrence of the other item(s) of data or another event relating thereto); a correlation, relationship, or causation between an event and another event (e.g., occurrence of another event); a relationship (e.g., causal relationship or other relationship) between a first variable(s) and a second variable(s); a relationship between the use of a particular graph primitive(s) during a data analysis (e.g., causal analysis of a graph(s)) and an outcome (e.g., accuracy of the outcome) of the data analysis; and/or to perform other desired functions or operations, and/or to automate one or more functions or features of the disclosed subject matter, as described herein.

With further regard to the processor component 206 and the data store 208 of or associated with the proof manager component 102, the processor component 206 can be associated with (e.g., communicatively connected to) and can work in conjunction with other components of the proof manager component 102 and/or the system 100, including the graph processor component 104, the proof generator component 106, the proof key component 202, the graph generator component 204, the data store 208, the AI component 224, and/or other components of the proof manager component 102 and/or the system 100, to facilitate performing the various functions and operations of the proof manager component 102 and/or the system 100. The processor component 206 can employ one or more processors (e.g., one or more central processing units (CPUs), accelerators, graphics processing units (GPUs), application-specific integrated circuits (ASICs), field-programmable gate arrays (FPGAs), microprocessors, controllers, and/or microcontrollers that can process information relating to data, instructions, files, datasets (e.g., data analytics flows or other datasets), graphs (e.g., DAGs or other graphs), subgraphs, matrices, circuits (e.g., ZK circuits or other proof circuits), computational tasks, cryptographic keys, proofs (e.g., 210), computational results, services, applications, AI-based models, AI-related data, training data, feedback information, updates, predictions, inferences, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., enhanced graph processing algorithms, enhanced graph primitive algorithms, enhanced proof generation management algorithms, AI algorithms, hash algorithms, data compression algorithms, data decompression algorithms, and/or other algorithm), interfaces, protocols, tools, and/or other information, to facilitate operation of the proof manager component 102 and/or the system 100, and control data flow between the proof manager component 102 and/or other components (e.g., device 112 or other device, network equipment or components, communication network, server, node, application, service, user, or other entity) associated with the proof manager component 102 and/or the system 100.

The data store 208 can store data structures (e.g., user data, metadata), code structure(s) (e.g., modules, objects, hashes, classes, procedures) or instructions, information relating to data, instructions, files, datasets (e.g., data analytics flows or other datasets), graphs (e.g., DAGs or other graphs), subgraphs, matrices, circuits (e.g., ZK circuits or other proof circuits), computational tasks, cryptographic keys, proofs (e.g., 210), computational results, services, applications, AI-based models, AI-related data, training data, feedback information, updates, predictions, inferences, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., enhanced graph processing algorithms, enhanced graph primitive algorithms, enhanced proof generation management algorithms, AI algorithms, hash algorithms, data compression algorithms, data decompression algorithms, and/or other algorithm), interfaces, protocols, tools, and/or other information, to facilitate controlling or performing operations associated with the proof manager component 102 and/or the system 100. The data store 208 can comprise volatile and/or non-volatile memory, such as described herein. In an aspect, the processor component 206 can be functionally coupled (e.g., through a memory bus) to the data store 208 in order to store and retrieve information desired to operate and/or confer functionality, at least in part, to the graph processor component 104, the proof generator component 106, the proof key component 202, graph generator component 204, processor component 206, data store 208, AI component 212, and/or other component of the proof manager component 102 and/or the system 100, and/or substantially any other operational aspects of the proof manager component 102 and/or the system 100.

The data store 208 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the processor component 406 and the data store 408 of or associated with the verifier manager component 114, the processor component 406 can be associated with (e.g., communicatively connected to) and can work in conjunction with other components of the verifier manager component 114 and/or the system 100, including the verifier key component 402, the verifier component 404, the data store 408, and/or other components of the verifier manager component 114 and/or the system 100, to facilitate performing the various functions and operations of the verifier manager component 114 and/or the system 100. The processor component 406 can employ one or more processors (e.g., one or more CPUs, accelerators, GPUs, ASICs, FPGAs, microprocessors, controllers, and/or microcontrollers that can process information relating to data, instructions, files, services, applications, cryptographic keys, proofs, computational results, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., proof verification and management algorithms, hash algorithms, data compression algorithms, data decompression algorithms, and/or other algorithm), interfaces, protocols, tools, and/or other information, to facilitate operation of the verifier manager component 114 and/or the system 100, and control data flow between the verifier manager component 114 and/or other components (e.g., the proof manager component 102, network equipment or components, communication network, device, server, node, application, service, user, or other entity) associated with the verifier manager component 114 and/or the system 100.

The data store 408 can store data structures (e.g., user data, metadata), code structure(s) (e.g., modules, objects, hashes, classes, procedures) or instructions, information relating to data, instructions, files, services, applications, cryptographic keys, proofs, computational results, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., proof verification and management algorithms, hash algorithms, data compression algorithms, data decompression algorithms, and/or other algorithm), interfaces, protocols, tools, and/or other information, to facilitate controlling or performing operations associated with the verifier manager component 114 and/or the system 100. The data store 408 can comprise volatile and/or non-volatile memory, such as described herein. In an aspect, the processor component 406 can be functionally coupled (e.g., through a memory bus) to the data store 408 in order to store and retrieve information desired to operate and/or confer functionality, at least in part, to the verifier key component 402, the verifier component 404, the processor component 406, the data store 408, and/or other component of the verifier manager component 114 and/or the system 100, and/or substantially any other operational aspects of the verifier manager component 114 and/or the system 100.

It is to be appreciated and understood that one or more components (e.g., the proof manager component 102, the device 112, the verifier manager component 114, a server(s) of the systems (e.g., system 100 or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

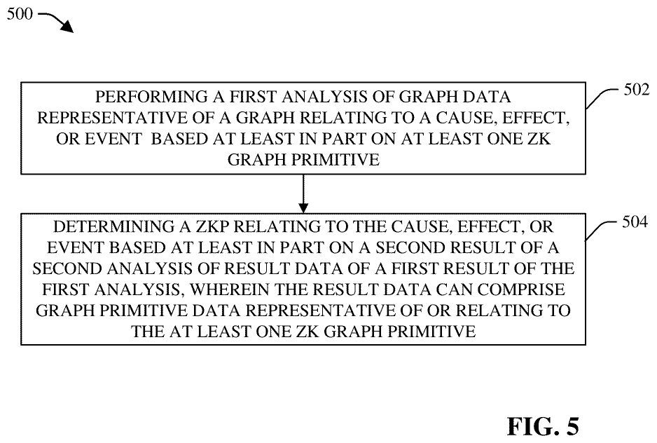

In view of the example systems and/or devices described herein, example methods that can be implemented in accordance with the disclosed subject matter can be further appreciated with reference to flowcharts in FIGS. 5-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 5 illustrates a flow chart of an example method 500 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing one or more graph primitives (e.g., tailored or customized graph primitives), in accordance with various aspects and embodiments of the disclosed subject matter. The method 500 can be employed by, for example, a system that can comprise the proof manager component that can comprise or be associated with the processor component, the data store, and/or other components, wherein the proof manager component can comprise the graph processor component and the proof generator component.

At 502, a first analysis of graph data representative of a graph relating to a cause(s), effect(s), and/or event(s) can be performed based at least in part on at least one ZK graph primitive. In some embodiments, the graph processor component can perform the first analysis (e.g., causal analysis) of the graph data representative of the graph (e.g., causal graph or causal DAG) relating to the cause(s), effect(s), and/or event(s) based at least in part on at least one ZK graph primitive. The at least one ZK graph primitive can comprise a first ZK graph primitive that can identify descendant nodes and ancestor nodes of a node in the graph, a second ZK graph primitive that can determine whether the graph is acyclic and perform acyclic or cyclic graph processing, a third ZK graph primitive that can assess whether two subgroups of a group of nodes of the graph are d-separated, a fourth ZK graph primitive that can generate an interventional graph for a target node of the graph, and/or another desired ZK graph primitive, such as described herein.

At 504, a ZKP relating to the cause(s), effect(s), and/or event(s) can be determined based at least in part on a second result of a second analysis of result data of a first result of the first analysis, wherein the result data can comprise graph primitive data representative of or relating to the at least one ZK graph primitive. For instance, the proof generator component can determine and generate the ZKP relating to the cause(s), effect(s), and/or event(s) based at least in part on the second result of the second analysis of the result data of the first result of the first analysis. The result data can comprise the graph primitive data representative of or relating to the at least one ZK graph primitive and/or other result data resulting from the first analysis.

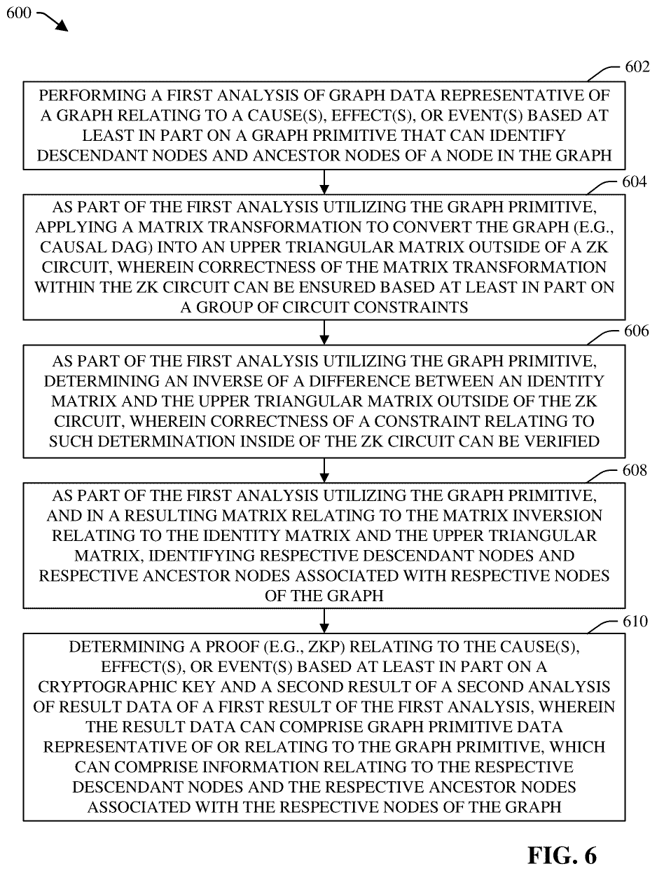

FIG. 6 depicts a flow chart of an example method 600 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing a graph primitive that can facilitate identification of descendant nodes and ancestor nodes of a node in a graph, in accordance with various aspects and embodiments of the disclosed subject matter. The method 600 can be employed by, for example, a system that can comprise the proof manager component that can comprise or be associated with the processor component, the data store, and/or other components, wherein the proof manager component can comprise the graph processor component and the proof generator component.

At 602, a first analysis of graph data representative of a graph relating to cause(s), effect(s), and/or event(s) can be performed based at least in part on a graph primitive (e.g., ZK graph primitive) that can identify descendant nodes and ancestor nodes of a node in the graph. In some embodiments, the graph processor component can perform the first analysis (e.g., causal analysis) of the graph data representative of the graph (e.g., causal graph or causal DAG) relating to the cause(s), effect(s), and/or event(s) based at least in part on the ZK graph primitive that can identify descendant nodes and ancestor nodes of a node in the graph.

At 604, as part of the first analysis utilizing the graph primitive, a matrix transformation can be applied to convert the graph (e.g., causal DAG) into an upper triangular matrix outside of a ZK circuit, wherein correctness of the matrix transformation within the ZK circuit can be ensured based at least in part on a group of circuit constraints. The graph processor component can apply the matrix transformation to the graph (e.g., graph data representative of the graph) to convert the graph (e.g., causal DAG) into the upper triangular matrix outside of the ZK circuit, wherein the correctness of the matrix transformation within the ZK circuit can be ensured based at least in part on the group of circuit constraints, such as described herein.

At 606, as part of the first analysis utilizing the graph primitive, an inverse of a difference between an identity matrix and the upper triangular matrix outside of the ZK circuit can be determined, wherein correctness of a constraint relating to such determination inside of the ZK circuit can be verified. For instance, the graph processor component can determine (e.g., calculate) the inverse of the difference between the identity matrix and the upper triangular matrix outside of the ZK circuit based at least in part on the results of analyzing the upper triangular matrix and the identity matrix. In some embodiments, the graph processor component can verify the correctness of the constraint relating to such determination by utilizing (e.g., applying) Freivalds' algorithm, such as described herein.

At 608, as part of the first analysis utilizing the graph primitive, and in a resulting matrix relating to the matrix inversion relating to the identity matrix and the upper triangular matrix, respective descendant nodes and respective ancestor nodes associated with respective nodes of the graph can be identified. In some embodiments, in or from the resulting matrix, the graph processor component can identify (e.g., determine) the respective descendant nodes and the respective ancestor nodes associated with the respective nodes of the graph (e.g., causal DAG), such as described herein.

At 610, a proof (e.g., a ZKP) relating to the cause(s), effect(s), and/or event(s) can be determined based at least in part on a cryptographic key and a second result of a second analysis of result data of a first result of the first analysis, wherein the result data can comprise graph primitive data representative of or relating to the graph primitive, which can comprise information relating to the respective descendant nodes and the respective ancestor nodes associated with the respective nodes of the graph. For instance, the proof generator component can determine and generate the ZKP relating to the cause(s), effect(s), and/or event(s) based at least in part on the cryptographic key (e.g., a private encryption key) and the second result of the second analysis of the result data of the first result of the first analysis. The result data can comprise the graph primitive data representative of or relating to the graph primitive and/or other result data resulting from the first analysis, wherein the graph primitive data can relate, at least in part, to the respective descendant nodes and the respective ancestor nodes associated with the respective nodes of the graph.

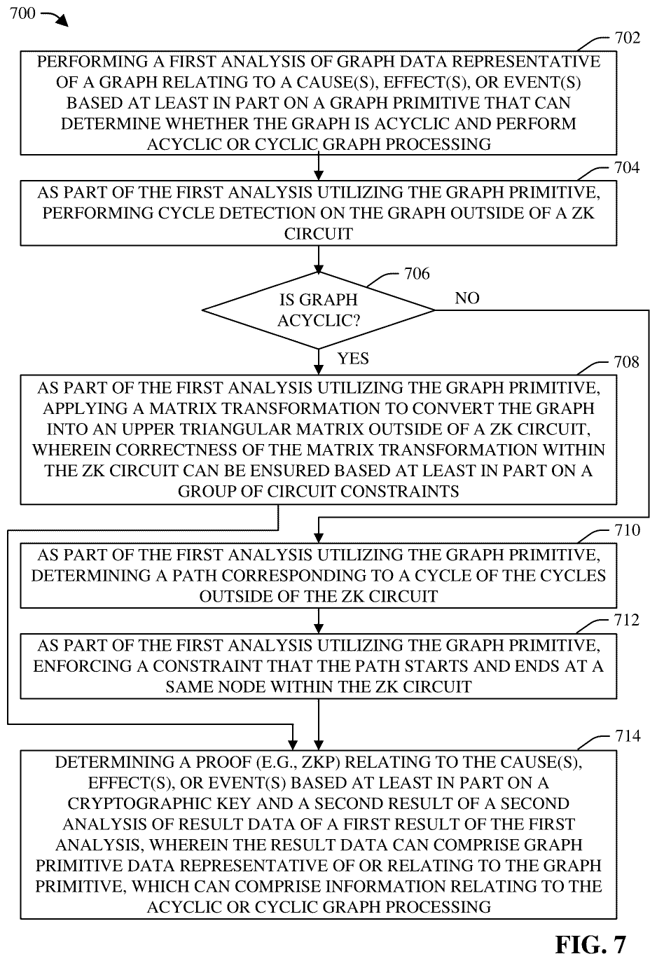

FIG. 7 illustrates a flow chart of an example method 700 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing a graph primitive that can facilitate determining whether a graph is acyclic and performing acyclic or cyclic graph processing, in accordance with various aspects and embodiments of the disclosed subject matter. The method 700 can be employed by, for example, a system that can comprise the proof manager component that can comprise or be associated with the processor component, the data store, and/or other components, wherein the proof manager component can comprise the graph processor component and the proof generator component.

At 702, a first analysis of graph data representative of a graph relating to a cause(s), effect(s), and/or event(s) can be performed based at least in part on a graph primitive (e.g., ZK graph primitive) that can determine whether the graph is acyclic and perform acyclic or cyclic graph processing. In some embodiments, the graph processor component can perform the first analysis (e.g., causal analysis) of the graph data representative of the graph (e.g., causal graph or causal DAG) relating to the cause(s), effect(s), and/or event(s) based at least in part on the graph primitive that can determine whether the graph is acyclic and perform acyclic or cyclic graph processing.

At 704, as part of the first analysis utilizing the graph primitive, cycle detection can be performed on the graph outside of a ZK circuit. In some embodiments, the graph processor component can perform the cycle detection on the graph outside of the ZK circuit. For instance, the graph processor component can check for the presence of cycles in the graph outside of the ZK circuit.

At 706, as part of the first analysis utilizing the graph primitive, a determination can be made regarding whether the graph is acyclic or cyclic, based at least in part on the performance of the cycle detection. In certain embodiments, the graph processor component can determine whether the graph is acyclic or cyclic based at least in part on the results of performing the cycle detection on the graph outside of the ZK circuit.

As part of the first analysis utilizing the graph primitive, if it is determined that the graph is acyclic, at 708, a matrix transformation can be applied to convert the graph into an upper triangular matrix outside of a ZK circuit, wherein correctness of the matrix transformation within the ZK circuit can be ensured based at least in part on a group of circuit constraints. In certain embodiments, the graph processor component can apply the matrix transformation to the graph (e.g., graph data representative of the graph) to convert the graph (e.g., causal DAG) into the upper triangular matrix outside of the ZK circuit, wherein the correctness of the matrix transformation within the ZK circuit can be ensured based at least in part on the group of circuit constraints, such as described herein. In some embodiments, at this point, the method 700 can proceed to reference numeral 714, and can continue from that point.

Referring again to reference numeral 706, as part of the first analysis utilizing the graph primitive, if, instead, at 706, it is determined that the graph is cyclic, at 710, a path corresponding to a cycle of the cycles outside of the ZK circuit can be determined. If the graph processor component determines that the graph is cyclic (e.g., a causal cyclic graph), the graph processor component can determine (e.g., compute) the path corresponding to the cycle outside of the ZK circuit.

At 712, as part of the first analysis utilizing the graph primitive, a constraint that the path starts and ends at a same node within the ZK circuit can be enforced. In certain embodiments, the graph processor component can enforce the constraint that the path starts and ends at the same node within the ZK circuit. In some embodiments, at this point, the method 700 can proceed to reference numeral 714, and can continue from that point.

At 714, a proof (e.g., a ZKP) relating to the cause(s), effect(s), and/or event(s) can be determined based at least in part on a cryptographic key and a second result of a second analysis of result data of a first result of the first analysis, wherein the result data can comprise graph primitive data representative of or relating to the graph primitive, which can comprise information relating to the acyclic or cyclic graph processing, such as described herein (e.g., as described herein with regard to reference numerals 708, 710, and 712, and/or as otherwise described herein). For instance, the proof generator component can determine and generate the ZKP relating to the cause(s), effect(s), and/or event(s) based at least in part on the cryptographic key (e.g., a private encryption key) and the second result of the second analysis of the result data of the first result of the first analysis. The result data can comprise the graph primitive data representative of or relating to the graph primitive and/or other result data resulting from the first analysis, wherein the graph primitive data can relate, at least in part, to the acyclic or cyclic graph processing.

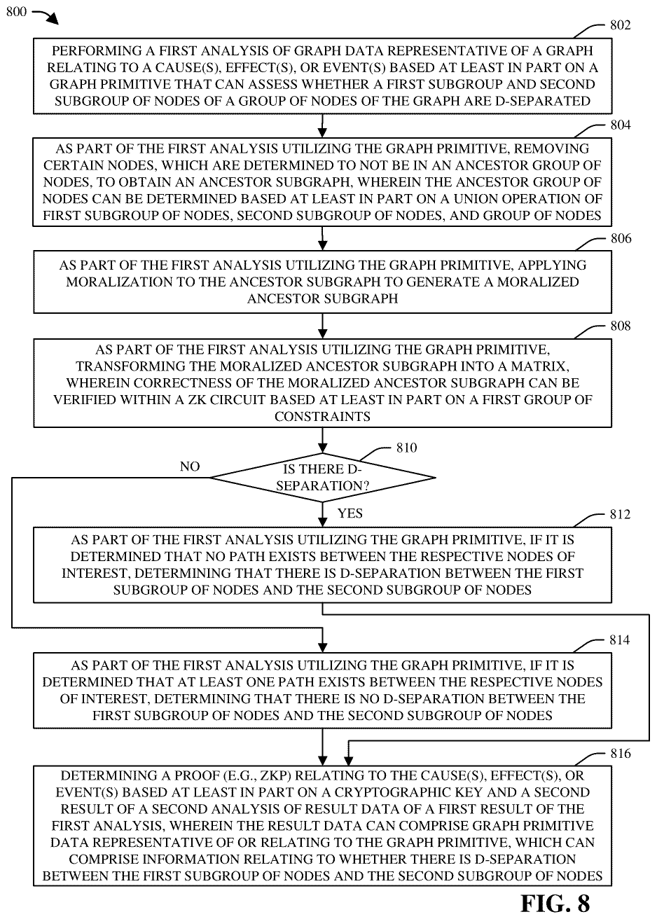

FIG. 8 depicts a flow chart of an example method 800 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing a graph primitive that can facilitate assessing whether a first subgroup of nodes and a second subgroup of nodes of a group of nodes of the graph are d-separated, in accordance with various aspects and embodiments of the disclosed subject matter. The method 800 can be employed by, for example, a system that can comprise the proof manager component that can comprise or be associated with the processor component, the data store, and/or other components, wherein the proof manager component can comprise the graph processor component and the proof generator component.

At 802, a first analysis of graph data representative of a graph relating to a cause(s), effect(s), and/or event(s) can be performed based at least in part on a graph primitive (e.g., a ZK graph primitive) that can assess whether a first subgroup of nodes and a second subgroup of nodes of a group of nodes of the graph are d-separated. In some embodiments, the graph processor component can perform the first analysis (e.g., causal analysis) of the graph data representative of the graph (e.g., causal DAG) relating to the cause(s), effect(s), and/or event(s) based at least in part on the graph primitive that can assess whether the first subgroup of nodes and the second subgroup of nodes of the graph are d-separated.

At 804, as part of the first analysis utilizing the graph primitive, certain nodes, which are determined to not be in an ancestor group of nodes, can be removed to obtain an ancestor subgraph, wherein the ancestor group of nodes can be determined based at least in part on a union operation of the first subgroup of nodes, the second subgroup of nodes, and the group of nodes. In some embodiments, the graph processor component can determine the ancestor group of nodes based at least in part on the result of performing the union operation on the first subgroup of nodes, the second subgroup of nodes, and the group of nodes. Based at least in part on the results of analyzing the ancestor group of nodes, the first subgroup of nodes, the second subgroup of nodes, and/or the group of nodes, the graph processor component can determine the certain nodes that are not in the ancestor group of nodes. The graph processor component can remove those certain nodes to generate the ancestor subgraph, which can comprise the ancestor group of nodes.

At 806, as part of the first analysis utilizing the graph primitive, moralization can be applied to the ancestor subgraph to generate a moralized ancestor subgraph. In certain embodiments, the graph processor component can apply moralization to the ancestor subgraph to generate the moralized ancestor subgraph, such as described herein. In some embodiments, the graph processor component can verify the moralized ancestor subgraph by utilizing (e.g., applying) Freivalds' algorithm, such as described herein. In some embodiments, the graph processor component can add and/or enforce certain constraints for the moralized ancestor subgraph, such as described herein.

At 808, as part of the first analysis utilizing the graph primitive, the moralized ancestor subgraph can be transformed into a matrix, wherein correctness of the moralized ancestor subgraph can be verified within a ZK circuit based at least in part on a first group of constraints. In some embodiments, the graph processor component can transform the moralized ancestor subgraph into the matrix, and can verify the correctness of the moralized ancestor subgraph within the ZK circuit based at least in part on the first group of constraints, such as described herein.

At 810, as part of the first analysis utilizing the graph primitive, a determination can be made regarding whether there is d-separation between the first subgroup of nodes and the second subgroup of nodes based at least in part on a result of determining, utilizing matrix operations, whether there is any path between respective nodes of interest of the first subgroup of nodes and the second subgroup of nodes, wherein a second group of constraints can be enforced within the ZK circuit to verify correctness of the matrix operations. In some embodiments, the graph processor component can determine whether there is d-separation between the first subgroup of nodes and the second subgroup of nodes based at least in part on the result of determining, utilizing the matrix operations, whether there is any path between respective nodes of interest of the first subgroup of nodes and the second subgroup of nodes. In certain embodiments, the graph processor component (e.g., employing Freivalds' algorithm) can enforce the second group of constraints within the ZK circuit to verify correctness of the matrix operations.

At 812, as part of the first analysis utilizing the graph primitive, if it is determined that no path exists between the respective nodes of interest, a determination can be made that there is d-separation between the first subgroup of nodes and the second subgroup of nodes. For instance, if the graph processor component determines that no path exists between the respective nodes of interest, the graph processor component can determine that there is d-separation between the first subgroup of nodes and the second subgroup of nodes. In some embodiments, at this point, the method 800 can proceed to reference numeral 816, and can continue from that point.

Referring again to reference numeral 810, as part of the first analysis utilizing the graph primitive, if, instead, at 810, it is determined that at least one path exists between the respective nodes of interest, at 814, a determination can be made that there is no d-separation between the first subgroup of nodes and the second subgroup of nodes. For example, if the graph processor component determines that at least one path exists between the respective nodes of interest, the graph processor component can determine that there is no d-separation between the first subgroup of nodes and the second subgroup of nodes. In some embodiments, at this point, the method 800 can proceed to reference numeral 816, and can continue from that point.

At 816, a proof (e.g., a ZKP) relating to the cause(s), effect(s), and/or event(s) can be determined based at least in part on a cryptographic key and a second result of a second analysis of result data of a first result of the first analysis, wherein the result data can comprise graph primitive data representative of or relating to the graph primitive, which can comprise information relating to whether there is d-separation between the first subgroup of nodes and the second subgroup of nodes, such as described herein. For instance, the proof generator component can determine and generate the ZKP relating to the cause(s), effect(s), and/or event(s) based at least in part on the cryptographic key (e.g., a private encryption key) and the second result of the second analysis of the result data of the first result of the first analysis. The result data can comprise the graph primitive data representative of or relating to the graph primitive and/or other result data resulting from the first analysis, wherein the graph primitive data can relate, at least in part, to and/or can indicate whether there is d-separation between the first subgroup of nodes and the second subgroup of nodes.

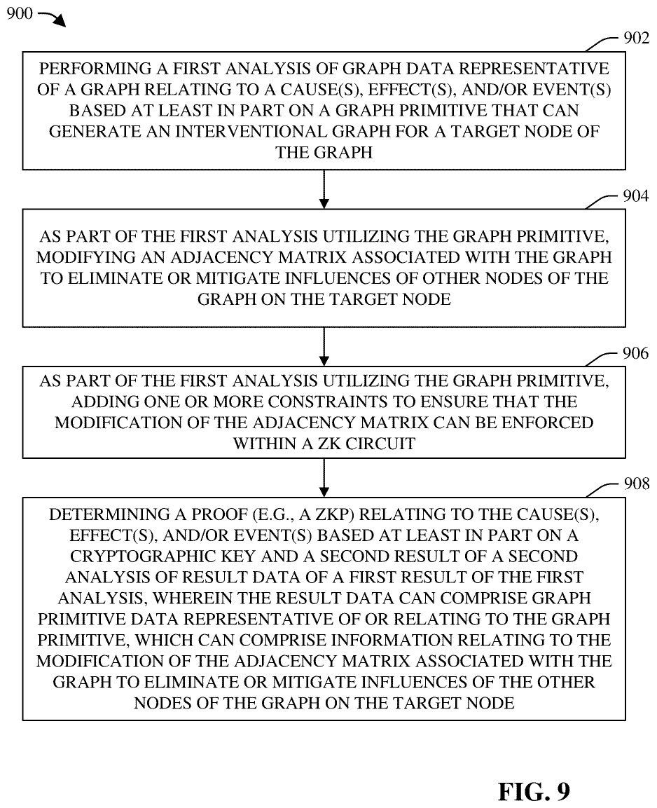

FIG. 9 illustrates a flow chart of an example method 900 that can desirably (e.g., automatically, dynamically, suitably, efficiently, reliably, enhancedly, and/or optimally) perform and manage data analysis (e.g., causal analysis, correlation analysis, and/or other type of analysis) and proof (e.g., ZKP) generation relating to such data analysis utilizing a graph primitive that can facilitate generating an interventional graph for a target node of a graph to facilitate eliminating or mitigating influences of other nodes of the graph on the target node, in accordance with various aspects and embodiments of the disclosed subject matter. The method 900 can be employed by, for example, a system that can comprise the proof manager component that can comprise or be associated with the processor component, the data store, and/or other components.

At 902, a first analysis of graph data representative of a graph relating to a cause(s), effect(s), and/or event(s) can be performed based at least in part on a graph primitive (e.g., a ZK graph primitive) that can generate an interventional graph for a target node of the graph. In some embodiments, the graph processor component can perform the first analysis (e.g., causal analysis) of the graph data representative of the graph (e.g., causal DAG) relating to the cause(s), effect(s), and/or event(s) based at least in part on the graph primitive that can generate the interventional graph for the target node of the graph.

At 904, as part of the first analysis utilizing the graph primitive, an adjacency matrix associated with the graph can be modified to eliminate or mitigate influences of other nodes of the graph on the target node. In some embodiments, the graph processor component can modify the adjacency matrix associated with the graph (e.g., to generate the interventional graph for the target node) to eliminate or mitigate influences of the other nodes of the graph on the target node. For example, the graph processor component can modify the adjacency matrix by setting entries in a column of the adjacency matrix corresponding to the target node to zero values.

At 906, as part of the first analysis utilizing the graph primitive, one or more constraints can be added to ensure that the modification of the adjacency matrix can be enforced within a ZK circuit. For instance, the graph processor component can add the one or more constraints to ensure that the modification of the adjacency matrix can be enforced within the ZK circuit.

At 908, a proof (e.g., a ZKP) relating to the cause(s), effect(s), and/or event(s) can be determined based at least in part on a cryptographic key and a second result of a second analysis of result data of a first result of the first analysis, wherein the result data can comprise graph primitive data representative of or relating to the graph primitive, which can comprise information relating to the modification of the adjacency matrix associated with the graph to eliminate or mitigate influences of the other nodes of the graph on the target node. In some embodiments, the proof generator component can determine and generate the ZKP relating to the cause(s), effect(s), and/or event(s) based at least in part on the cryptographic key (e.g., a private encryption key) and the second result of the second analysis of the result data of the first result of the first analysis. The result data can comprise the graph primitive data representative of or relating to the graph primitive and/or other result data resulting from the first analysis, wherein the graph primitive data can relate, at least in part, to the modification of the adjacency matrix associated with the graph (e.g., to generate the interventional graph for the target node) to eliminate or mitigate influences of the other nodes of the graph on the target node.

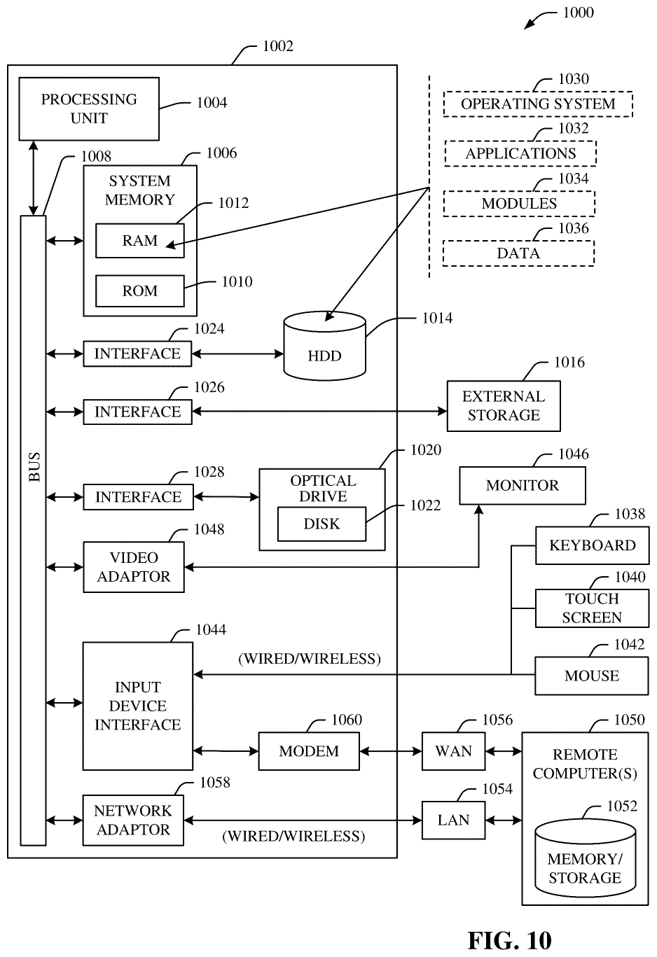

In order to provide additional context for various embodiments described herein, FIG. 10 and the following discussion are intended to provide a brief, general description of a suitable computing environment 1000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 also can be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056, e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., proof manager component, graph processor component, proof generator component, verifier manager component, AI component, model, device, server, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
performing, by a system comprising at least one processor, a first analysis of graph data representative of a graph relating to a cause, an effect, or an event based on at least one zero-knowledge graph primitive; and
determining, by the system, a zero-knowledge proof relating to the cause, the effect, or the event based on a second result of a second analysis of result data of a first result of the first analysis, wherein the result data comprises graph primitive data representative of the at least one zero-knowledge graph primitive.

2. The method of claim 1, wherein the graph is a causal directed acyclic graph or a causal cyclic graph, wherein the at least one zero-knowledge graph primitive is tailored for a causal analysis of data in a zero-knowledge application, and wherein the data comprises the graph primitive data or the graph data.

3. The method of claim 1, wherein the at least one zero-knowledge graph primitive comprises a zero-knowledge graph primitive comprising a group of nodes and a group of edges associated with the group of nodes, the zero-knowledge graph primitive having a graph primitive characteristic whereby removal of any edge of the group of edges from the zero-knowledge graph primitive results in disconnection of the zero-knowledge graph primitive.

4. The method of claim 1, wherein the at least one zero-knowledge graph primitive comprises a first zero-knowledge graph primitive for identification of descendant nodes and ancestor nodes of a node in the graph, a second zero-knowledge graph primitive that determines whether the graph is acyclic and performs acyclic or cyclic graph processing, a third zero-knowledge graph primitive that assesses whether two subgroups of a group of nodes of the graph are d-separated, or a fourth zero-knowledge graph primitive that generates an interventional graph for a target node of the graph.

5. The method of claim 1, wherein the first result comprises a causal result, wherein the performing of the first analysis comprises performing, by the system, a causal analysis of data relating to the cause, the effect, or the event based on the at least one zero-knowledge graph primitive, and wherein the determining of the zero-knowledge proof comprises determining the zero-knowledge proof relating to the cause, the effect, or the event based on the causal result of the causal analysis and a cryptographic key.

6. The method of claim 1, further comprising:
communicating, by the system, the zero-knowledge proof to a verifier device, wherein the zero-knowledge proof facilitates verification that the zero-knowledge proof, comprising analysis or computational result data, is correct, without revealing, to the verifier device, underlying data that was utilized to determine and generate the zero-knowledge proof, and wherein the underlying data comprises at least one of the graph data, data utilized to generate the graph data representative of the graph, or the graph primitive data.

7. The method of claim 1, wherein the graph is a causal directed acyclic graph, wherein the at least one zero-knowledge graph primitive comprises a zero-knowledge graph primitive for identification of descendant nodes and ancestor nodes of a node in the graph, and wherein the method further comprises:
applying, by the system, a matrix transformation to convert the causal directed acyclic graph into an upper triangular matrix outside of a zero-knowledge circuit, wherein correctness of the matrix transformation within the zero-knowledge circuit is ensured based on a group of circuit constraints;
determining, by the system, an inverse of a difference between an identity matrix and the upper triangular matrix outside of the zero-knowledge circuit;
verifying, by the system, correctness of the inverse of the difference between the identity matrix and the upper triangular matrix within the zero-knowledge circuit; and
in a resulting matrix relating to the identity matrix and the upper triangular matrix, identifying, by the system, respective descendant nodes and respective ancestor nodes associated with respective nodes of the causal directed acyclic graph.

8. The method of claim 1, wherein the graph is a causal graph, wherein the at least one zero-knowledge graph primitive comprises a zero-knowledge graph primitive relating, in part, to determining whether the causal graph is acyclic, and wherein the method further comprises:
performing, by the system, cycle detection on the causal graph, outside of a zero-knowledge circuit;
based on the performing of the cycle detection, determining, by the system, whether the causal graph is cyclic or acyclic; and
in response to determining that the causal graph is acyclic:
applying, by the system, a matrix transformation to convert the causal graph into an upper triangular matrix outside of a zero-knowledge circuit, wherein correctness of the matrix transformation within the zero-knowledge circuit is ensured based on a group of circuit constraints; or
in response to determining that the causal graph is cyclic, comprising cycles:
determining, by the system, a path corresponding to a cycle of the cycles outside of the zero-knowledge circuit; and
enforcing, by the system, a constraint that the path starts and ends at a same node within the zero-knowledge circuit.

9. The method of claim 1, wherein the graph is a causal directed acyclic graph, wherein the at least one zero-knowledge graph primitive comprises a zero-knowledge graph primitive that assesses whether a first subgroup of nodes and a second subgroup of nodes of a group of nodes of the causal directed acyclic graph are d-separated, and wherein the method further comprises:
removing, by the system, nodes that are determined to not be in an ancestor group of nodes to obtain an ancestor subgraph, wherein the ancestor group of nodes is determined based on a union operation of the first subgroup of nodes, the second subgroup of nodes, and the group of nodes;
applying, by the system, moralization to the ancestor subgraph to generate a moralized ancestor subgraph;
transforming, by the system, the moralized ancestor subgraph into a matrix, wherein correctness of the moralized ancestor subgraph is verified within a zero-knowledge circuit based on a first group of constraints; and
determining, by the system, whether there is d-separation between the first subgroup of nodes and the second subgroup of nodes based on a third result of determining, utilizing matrix operations, whether there is any path between respective nodes of interest of the first subgroup of nodes and the second subgroup of nodes, wherein a second group of constraints is enforced within the zero-knowledge circuit to verify correctness of the matrix operations.

10. The method of claim 9, further comprising:
determining, by the system, there is the d-separation between the first subgroup of nodes and the second subgroup of nodes based on the third result indicating non-existence of a path between the respective nodes of interest; or
determining, by the system, there is no d-separation between the first subgroup of nodes and the second subgroup of nodes based on the third result indicating an existence of the path between the respective nodes of interest.

11. The method of claim 1, wherein the graph is a causal directed acyclic graph, wherein the at least one zero-knowledge graph primitive comprises a zero-knowledge graph primitive that generates an interventional graph for a target node of the causal directed acyclic graph, and wherein the method further comprises:
modifying, by the system, an adjacency matrix associated with the causal directed acyclic graph by setting entries in a column of the adjacency matrix corresponding to the target node to zero values, wherein the modifying of the adjacency matrix facilitates eliminating influences of other nodes of the causal directed acyclic graph on the target node; and
adding, by the system, one or more constraints to ensure that the modifying of the adjacency matrix is enforced within a zero-knowledge circuit.

12. A system, comprising:
at least one memory that stores computer executable components; and
at least one processor that executes computer executable components stored in the at least one memory, wherein the computer executable components comprise:
a graph processor that performs a first analysis of graph information representative of a graph relating to a cause, an effect, or an event based on at least one zero-knowledge graph primitive; and
a proof generator that determines a zero-knowledge proof relating to the cause, the effect, or the event based on a second result of a second analysis of result information of a first result of the first analysis, wherein the result information comprises graph primitive information representative of the at least one zero-knowledge graph primitive.

13. The system of claim 12, wherein the graph is a causal directed acyclic graph or a causal cyclic graph, wherein the at least one zero-knowledge graph primitive is customized to facilitate a causal analysis of information in a zero-knowledge application, and wherein the information comprises the graph primitive information or the graph information.

14. The system of claim 12, wherein the at least one zero-knowledge graph primitive comprises a first zero-knowledge graph primitive for identification of descendant nodes and ancestor nodes of a node in the graph, a second zero-knowledge graph primitive that determines whether the graph is acyclic and performs acyclic or cyclic graph processing, a third zero-knowledge graph primitive that assesses whether two subgroups of a group of nodes of the graph are d-separated, or a fourth zero-knowledge graph primitive that generates an interventional graph for a target node of the graph.

15. The system of claim 12, wherein the first analysis comprises a causal analysis, wherein the first result comprises a causal result, and wherein the proof generator performs the causal analysis of information relating to the cause, the effect, or the event based on the at least one zero-knowledge graph primitive, and, based on the causal result of the causal analysis and a cryptographic key, determines the zero-knowledge proof relating to the cause, the effect, or the event.

16. The system of claim 12, wherein the proof generator transmits or facilitates transmission of the zero-knowledge proof to a verifier device, wherein the zero-knowledge proof facilitates validation that the zero-knowledge proof, comprising analysis or computational result information, is accurate, without divulging, to the verifier device, underlying information that was utilized to determine and generate the zero-knowledge proof, and wherein the underlying information comprises at least one of the graph information, information utilized to generate the graph information, or the graph primitive information.

17. The system of claim 12, wherein the graph processor or the proof generator comprises or utilizes an accelerator unit, a graphics processing unit, a field-programmable gate array, or an application specific integrated circuit.

18. A non-transitory machine-readable medium, comprising executable instructions that, when executed by at least one processor, facilitate performance of operations, comprising:
performing a first analysis of graph data of a graph relating to a cause, an effect, or an event based on at least one zero-knowledge graph primitive; and
generating a zero-knowledge proof relating to the cause, the effect, or the event based on a second result of a second analysis of result data of a first result of the first analysis, wherein the result data comprises graph primitive data of the at least one zero-knowledge graph primitive.

19. The non-transitory machine-readable medium of claim 18, wherein the graph is a causal directed acyclic graph or a causal cyclic graph, wherein the at least one zero-knowledge graph primitive is tailored for a causal analysis of data in a zero-knowledge application, wherein the data comprises the graph primitive data or the graph data, and
wherein the at least one zero-knowledge graph primitive comprises a first zero-knowledge graph primitive for identification of descendant nodes and ancestor nodes of a node in the graph, a second zero-knowledge graph primitive that determines whether the graph is acyclic and performs acyclic or cyclic graph processing, a third zero-knowledge graph primitive that assesses whether two subgroups of a group of nodes of the graph are d-separated, or a fourth zero-knowledge graph primitive that generates an interventional graph for a target node of the graph.

20. The non-transitory machine-readable medium of claim 18, wherein the operations further comprise:
communicating the zero-knowledge proof to a verifier device, wherein the zero-knowledge proof facilitates verification that the zero-knowledge proof, comprising analysis or computational result data, is correct, without exposing, to the verifier device, underlying data that was utilized to determine and generate the zero-knowledge proof, and wherein the underlying data comprises at least one of the graph data, data utilized to generate the graph data representative of the graph, or the graph primitive data.
